(19) United States
(12) Patent Application Publication
(10) Pub. No.: US 2025/0005975 A1
(43) Pub. Date: Jan. 2, 2025

(54) SYSTEMS AND METHODS FOR ANALYZING A VEHICLE NOISE

(71) Applicant: Toyota Motor North America, Inc., Plano, TX (US)

(72) Inventors: Moez Padani, Plano, TX (US); Garry Davis, Keller, TX (US); Apoorva Radhakrishnan, Bangalore (IN)

(73) Assignees: Toyota Motor North America, Inc., Plano, TX (US); Toyota Jidosha Kabushiki Kaisha, Aichi-ken (JP)

(21) Appl. No.: 18/215,231

(22) Filed: Jun. 28, 2023

(51) Int. Cl. G07C 5/08; G06Q 10/1093; G06Q 10/20; G07C 5/00

(52) U.S. Cl. CPC G07C 5/0825; G06Q 10/1095; G06Q 10/20; G07C 5/008; G07C 5/0808

(57) ABSTRACT

Systems and methods for analyzing a vehicle noise are provided. The systems include a controller programmed to: collect a vehicle noise through a device, convert the vehicle noise to a spectrogram, obtain a fingerprint of the vehicle noise including one or more features of the spectrogram, compare the fingerprint of the vehicle noise and predetermined fingerprints associated with different classifications, and identify a classification of the vehicle noise based on the comparison of the fingerprint of the vehicle noise and the predetermined fingerprints.

### TECHNICAL FIELD

The present disclosure relates to systems and methods for analyzing a vehicle noise.

### BACKGROUND

Accurately analyzing a vehicle noise may be desired for many reasons. Conventional systems and methods generally focus on visual inspections of vehicle issues to figure out the vehicle noise. However, the users of the vehicles may not recognize vehicle issues including brake issues by visual inspections. Moreover, it is difficult to determine whether the vehicles need to be inspected by visual inspections.

Accordingly, a need exists for systems and methods that accurately analyze a vehicle noise.

### SUMMARY

The present disclosure provides systems and methods for analyzing a vehicle noise. The systems and methods accurately analyze a vehicle noise by converting the vehicle noise to a spectrogram, obtaining a fingerprint of the vehicle noise including one or more features of the spectrogram, and comparing the fingerprint of the vehicle noise and predetermined fingerprints associated with different classifications. With the accurate analysis of the vehicle noise, the vehicles may have an efficient motion system, such as acceleration, deceleration, and avoid undesired situations.

In one or more embodiments, a system of analyzing a vehicle noise includes a controller. The controller is programmed to collect a vehicle noise through a device, convert the vehicle noise to a spectrogram, obtain a fingerprint of the vehicle noise including one or more features of the spectrogram, compare the fingerprint of the vehicle noise and predetermined fingerprints associated with different classifications, and identify a classification of the vehicle noise based on the comparison of the fingerprint of the vehicle noise and the predetermined fingerprints.

In another embodiment, a method of analyzing a vehicle noise includes collecting a vehicle noise through a device, converting the vehicle noise to a spectrogram, obtaining a fingerprint of the vehicle noise including one or more features of the spectrogram, comparing the fingerprint of the vehicle noise and predetermined fingerprints associated with different classifications, and identifying a classification of the vehicle noise based on the comparison of the fingerprint of the vehicle noise and the predetermined fingerprints.

These and additional features provided by the embodiments of the present disclosure will be more fully understood in view of the following detailed description, in conjunction with the drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 depicts a schematic diagram of systems of analyzing a vehicle noise, according to one or more embodiments shown and described herein;

FIGS. 2A-2G depict exemplary systems of analyzing a vehicle noise, according to one or more embodiments shown and described herein; and

FIG. 3 depicts a flowchart for methods of analyzing a vehicle noise, according to one or more embodiments shown and described herein.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The embodiments disclosed herein include systems and methods for analyzing a vehicle noise. The systems and methods accurately analyze a vehicle noise by collecting a vehicle noise through a device, converting the vehicle noise to a spectrogram, obtaining a fingerprint of the vehicle noise including one or more features of the spectrogram, comparing the fingerprint of the vehicle noise and predetermined fingerprints associated with different classifications, and identifying a classification of the vehicle noise based on the comparison of the fingerprint of the vehicle noise and the predetermined fingerprints. With the accurate analysis of the vehicle noise, the vehicles may have an efficient motion system, such as acceleration, deceleration, and avoid undesired situations.

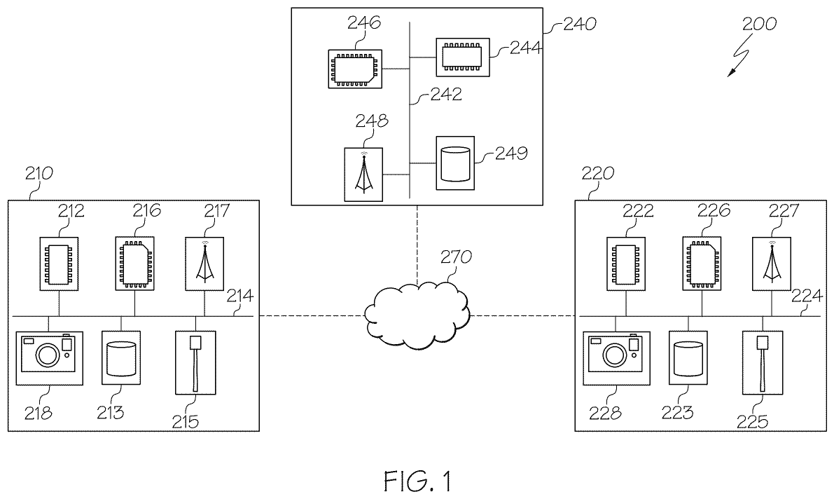

FIG. 1 depicts a schematic diagram of systems of analyzing a vehicle noise, according to one or more embodiments shown and described herein.

Referring to FIG. 1, the system 200 includes a vehicle system 210, a device system 220, and the server 240.

The vehicle system 210 includes one or more processors 212. Each of the one or more processors 212 may be any device capable of executing machine-readable and executable instructions. Each of the one or more processors 212 may be a controller, an integrated circuit, a microchip, a computer, or any other computing device. One or more processors 212 are coupled to a communication path 214 that provides signal interconnectivity between various modules of the system. The communication path 214 may communicatively couple any number of processors 212 with one another, and allow the modules coupled to the communication path 214 to operate in a distributed computing environment. Each of the modules may operate as a node that may send and/or receive data. As used herein, the term “communicatively coupled” means that coupled components are capable of exchanging data signals with one another such as electrical signals via a conductive medium, electromagnetic signals via air, optical signals via optical waveguides, and the like.

The communication path 214 may be formed from any medium that is capable of transmitting a signal such as conductive wires, conductive traces, optical waveguides, or the like. In some embodiments, the communication path 214 may facilitate the transmission of wireless signals, such as WiFi, Bluetooth®, Near Field Communication (NFC), and the like. The communication path 214 may be formed from a combination of mediums capable of transmitting signals. In one embodiment, the communication path 214 comprises a combination of conductive traces, conductive wires, connectors, and buses that cooperate to permit the transmission of electrical data signals to components such as processors, memories, sensors, input devices, output devices, and communication devices. The communication path 214 may comprise a vehicle bus, such as a LIN bus, a CAN bus, a VAN bus, and the like. Additionally, it is noted that the term “signal” means a waveform (e.g., electrical, optical, magnetic, mechanical, or electromagnetic), such as DC, AC, sinusoidal-wave, triangular-wave, square-wave, vibration, and the like, capable of traveling through a medium.

The vehicle system 210 includes one or more memory modules 216 coupled to the communication path 214 and may contain non-transitory computer-readable medium comprising RAM, ROM, flash memories, hard drives, or any device capable of storing machine-readable and executable instructions such that the machine-readable and executable instructions can be accessed by the one or more processors 212. The machine-readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine-readable and executable instructions and stored in the one or more memory modules 216. The machine-readable and executable instructions may be written in a hardware description language (HDL), such as logic implemented via either a field-programmable gate array (FPGA) configuration or an application-specific integrated circuit (ASIC), or their equivalents. The methods described herein may be implemented in any conventional computer programming language, as pre-programmed hardware elements, or as a combination of hardware and software components. The one or more processors 212 along with the one or more memory modules 216 may operate as a controller for the vehicle system 210.

Still referring to FIG. 1, the vehicle system 210 includes one or more sensors 218. One or more sensors 218 may be any device having an array of sensing devices capable of detecting radiation in an ultraviolet wavelength band, a visible light wavelength band, or an infrared wavelength band. One or more sensors 218 may detect the presence of the vehicle system 210, the presence of the device system 220, the location of the vehicle system 210, the location of the device system 220, the distance between the vehicle system 210 and the device system 220. One or more sensors 218 may have any resolution. In some embodiments, one or more optical components, such as a mirror, fish-eye lens, or any other type of lens may be optically coupled to one or more sensors 218. In some embodiments, one or more sensors 218 may provide image data to one or more processors 212 or another component communicatively coupled to the communication path 214. In some embodiments, one or more sensors 218 may provide navigation support. In embodiments, data captured by one or more sensors 218 may be used to autonomously or semi-autonomously navigate the vehicle system 210.

In some embodiments, one or more sensors 218 may include one or more audio sensors configured to record vehicle noises and transmit the recorded vehicle noises to the server 240. In some embodiments, one or more audio sensors may include microphones.

In some embodiments, one or more sensors 218 include one or more imaging sensors configured to operate in the visual and/or infrared spectrum to sense visual and/or infrared light. In some embodiments, one or more sensors 218 include one or more LIDAR sensors, radar sensors, sonar sensors, or other types of sensors for gathering data that could be integrated into or supplement the data collection. Ranging sensors like radar sensors may be used to obtain rough depth and speed information for the view of the vehicle system 210.

The vehicle system 210 includes a satellite antenna 215 coupled to the communication path 214 such that the communication path 214 communicatively couples the satellite antenna 215 to other modules of the vehicle system 210. The satellite antenna 215 is configured to receive signals from global positioning system satellites. In one embodiment, the satellite antenna 215 includes one or more conductive elements that interact with electromagnetic signals transmitted by global positioning system satellites. The received signal is transformed into a data signal indicative of the location (e.g., latitude and longitude) of the satellite antenna 215 or an object positioned near the satellite antenna 215, by one or more processors 212.

The vehicle system 210 includes one or more vehicle sensors 213. Each of one or more vehicle sensors 213 is coupled to the communication path 214 and communicatively coupled to one or more processors 212. One or more vehicle sensors 213 may include one or more motion sensors for detecting and measuring motion and changes in the motion of the vehicle system 210. The motion sensors may include inertial measurement units. Each of the one or more motion sensors may include one or more accelerometers and one or more gyroscopes. Each of one or more motion sensors transforms sensed physical movement of the vehicle into a signal indicative of an orientation, a rotation, a velocity, or an acceleration of the vehicle.

Still referring to FIG. 1, the vehicle system 210 includes a network interface hardware 217 for communicatively coupling the vehicle system 210 to the server 240. The network interface hardware 217 may be communicatively coupled to the communication path 214 and may be any device capable of transmitting and/or receiving data via a network. The network interface hardware 217 may include a communication transceiver for sending and/or receiving any wired or wireless communication. For example, the network interface hardware 217 may include an antenna, a modem, LAN port, WiFi card, WiMAX card, mobile communications hardware, near-field communication hardware, satellite communication hardware and/or any wired or wireless hardware for communicating with other networks and/or devices. In one embodiment, the network interface hardware 217 includes hardware configured to operate in accordance with the Bluetooth® wireless communication protocol. The network interface hardware 217 of the vehicle system 210 may transmit its data to the server 240. For example, the network interface hardware 217 of the vehicle system 210 may transmit vehicle data, location data, maneuver data, and the like to the server 240.

The vehicle system 210 may connect with one or more external vehicle systems (e.g., the device system 220) and/or external processing devices (e.g., a cloud server, an edge server, or boh) via a direct connection. The direct connection may be a vehicle-to-vehicle connection (“V2V connection”), a vehicle-to-everything connection (“V2X connection”), or an mmWave connection. The V2V or V2X connection or mmWave connection may be established using any suitable wireless communication protocols discussed above. A connection between vehicles may utilize sessions that are time-based and/or location-based. In embodiments, a connection between vehicles or between a vehicle and an infrastructure element may utilize one or more networks to connect, which may be in lieu of, or in addition to, a direct connection (such as V2V, V2X, mm Wave) between the vehicles or between a vehicle and an infrastructure.

Vehicles may function as infrastructure nodes to form a mesh network and connect dynamically on an ad-hoc basis. In this way, vehicles may enter and/or leave the network at will, such that the mesh network may self-organize and self-modify over time. The network may include vehicles forming peer-to-peer networks with other vehicles or utilizing centralized networks that rely upon certain vehicles and/or infrastructure elements. The network may include networks using the centralized server and other central computing devices to store and/or relay information between vehicles.

Still referring to FIG. 1, the vehicle system 210 may be communicatively coupled to the device system 220, the server 240, or both, by the network 270. In one embodiment, the network 270 may include one or more computer networks (e.g., a personal area network, a local area network, or a wide area network), cellular networks, satellite networks and/or a global positioning system and combinations thereof. The vehicle system 210 may be communicatively coupled to the network 270 via a wide area network, a local area network, a personal area network, a cellular network, a satellite network, etc. Suitable local area networks may include wired Ethernet and/or wireless technologies such as Wi-Fi. Suitable personal area networks may include wireless technologies such as IrDA, Bluetooth®, Wireless USB, Z-Wave, ZigBee, and/or other near field communication protocols. Suitable cellular networks include, but are not limited to, technologies such as LTE, WiMAX, UMTS, CDMA, and GSM.

Still referring to FIG. 1, the device system 220 includes one or more processors 222, one or more memory modules 226, one or more sensors 228, one or more device sensors 223, a satellite antenna 225, a network interface hardware 227, and a communication path 224 communicatively connected to the other components of device system 220. The components of the device system 220 may be structurally similar to and have similar functions as the corresponding components of the vehicle system 210 (e.g., the one or more processors 222 corresponds to the one or more processors 212, the one or more memory modules 226 corresponds to the one or more memory modules 216, the one or more sensors 228 corresponds to the one or more sensors 218, the satellite antenna 225 corresponds to the satellite antenna 215, the communication path 224 corresponds to the communication path 214, and the network interface hardware 227 corresponds to the network interface hardware 217). In some embodiments, one or more sensors 228 may include one or more audio sensors configured to record vehicle noises and transmit the recorded vehicle noises to the server 240. In some embodiments, one or more audio sensors may include microphones.

Still referring to FIG. 1, the server 240 includes one or more processors 244, one or more memory modules 246, a network interface hardware 248, one or more vehicle sensors 249, and a communication path 242 communicatively connected to the other components of the vehicle system 210. The components of the server 240 may be structurally similar to and have similar functions as the corresponding components of the vehicle system 210 (e.g., the one or more processors 244 corresponds to the one or more processors 212, the one or more memory modules 246 corresponds to the one or more memory modules 216, the one or more vehicle sensors 249 corresponds to the one or more vehicle sensors 213, the communication path 242 corresponds to the communication path 214, and the network interface hardware 248 corresponds to the network interface hardware 217). In some embodiments, one or more memory modules 246 may include a machine learning model, a random forest classifier, or both. In some embodiments, one or more memory modules 246 may include a database for storing fingerprints.

It should be understood that the components illustrated in FIG. 1 are merely illustrative and are not intended to limit the scope of this disclosure. More specifically, while the components in FIG. 1 are illustrated as residing within the vehicle system 210, this is a non-limiting example. In some embodiments, one or more of the components may reside external to the vehicle system 210, the device system 220, or both, such as with the server 240.

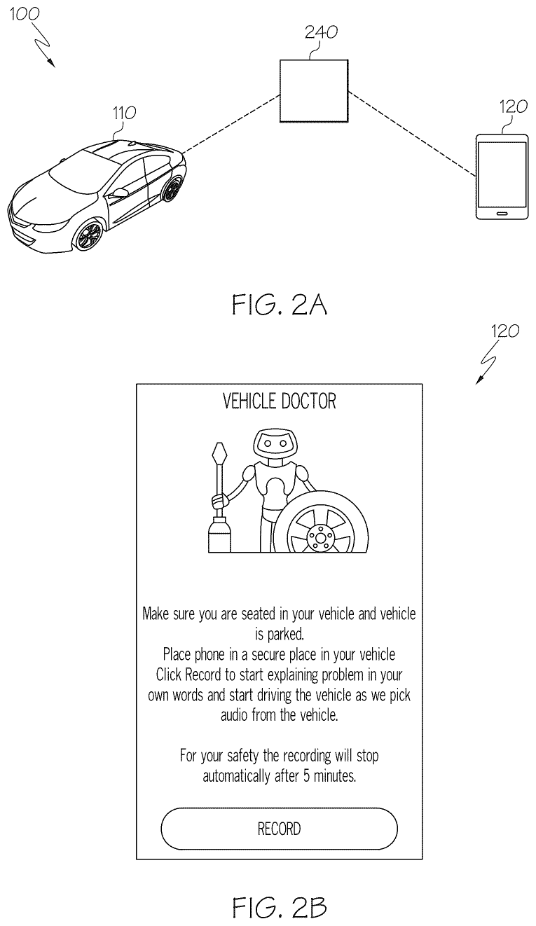

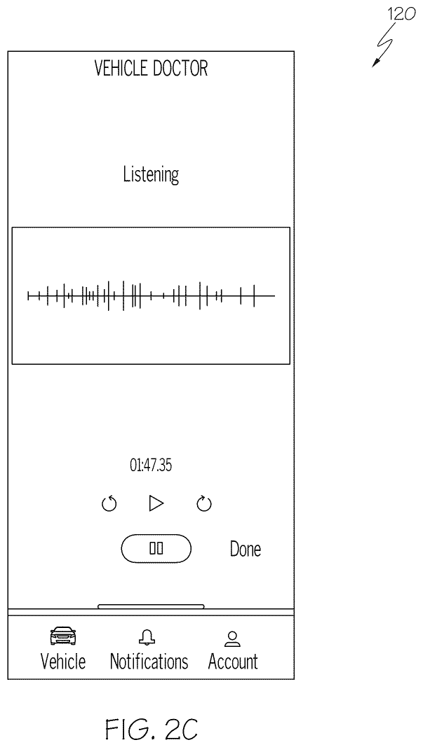

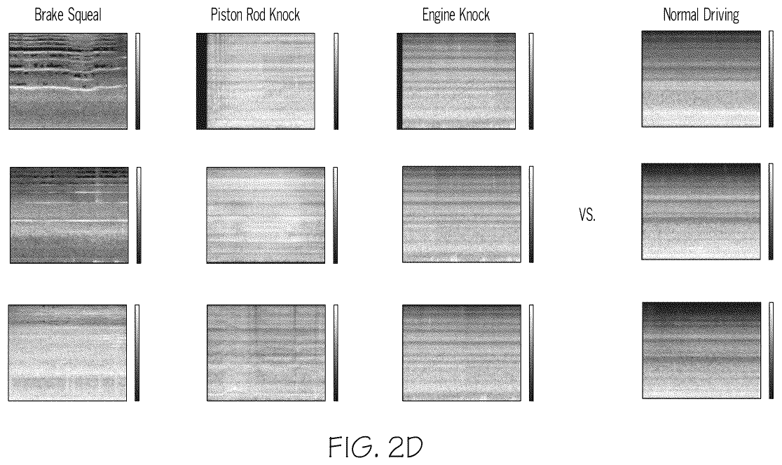

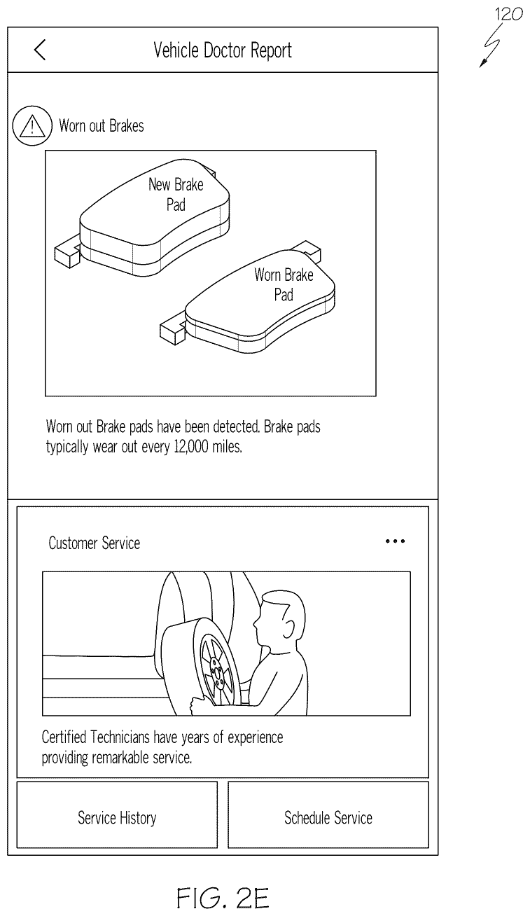

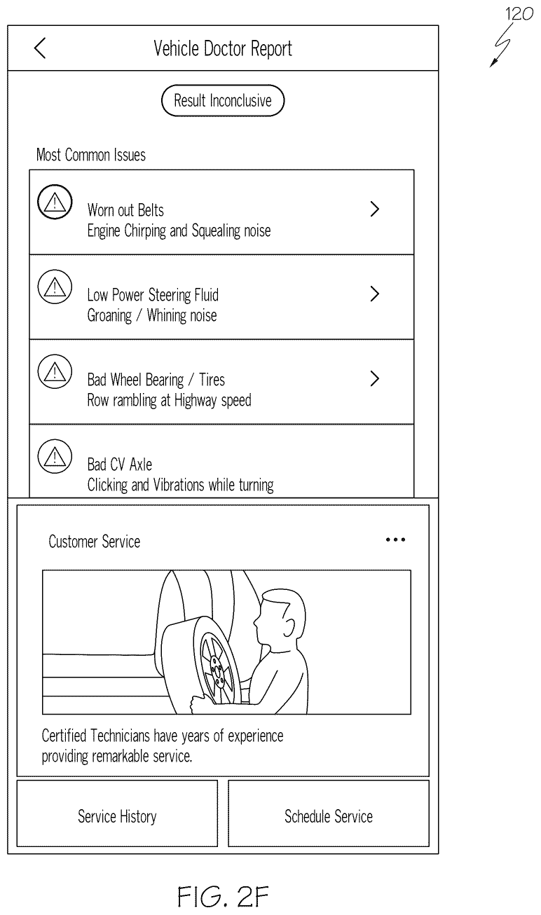

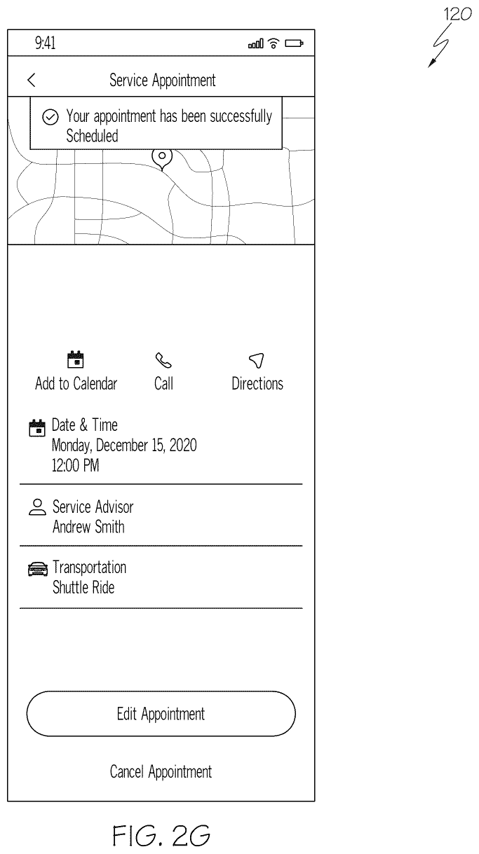

FIGS. 2A-2G depict exemplary systems of analyzing a vehicle noise, according to one or more embodiments shown and described herein.

Referring to FIG. 2A, the system 100 of analyzing a vehicle noise includes a vehicle 110, a device 120 and a server 240.

The vehicle 110 may be a vehicle including an automobile or any other passenger or non-passenger vehicle such as, for example, a terrestrial, aquatic, and/or airborne vehicle. In some embodiments, the vehicle 110 may be an autonomous driving vehicle. The vehicle 110 may be an autonomous vehicle that navigates its environment with limited human input or without human input. The vehicle 110 may be equipped with internet access and share data with other devices both inside and outside the vehicle 110. The vehicle 110 may communicate with the server 240, the device 120, or both, and transmit their data to the server 240, the device 120, or both. For example, the vehicle 110 transmits information about its current location and destination, its environment, information about a current user, information about a task that it is currently implementing, and the like. The vehicle 110 may include an actuator configured to move the vehicle 110.

The device 120 may be communicatively coupled to the vehicle 110, the server 240, or both. The device 120 may be a device of the user of the vehicle 110. The device 120 may be a display device in the vehicle 110, a display device of the user, or both. The display device may include a navigation device, a smartphone, a smartwatch, a laptop, a tablet computer, a personal computer, a wearable device, or combinations thereof.

In embodiments, the system 100 may activate an application on the device 120 to collect the vehicle noise. In some embodiments, prior to activating the application, the device 120 may be disposed in the vehicle 110. Referring to FIGS. 2A and 2B, the system 100 may provide the instruction, such as “Place phone in a secure place in your vehicle,” to a user through the application. In some embodiments, prior to activating the application, the vehicle 110 may be stationary. For example, the vehicle 110 may be parked. Referring to FIGS. 2A and 2B, the system 100 may provide the instructions, such as, “Make sure you are seated in your vehicle and vehicle is parked,” to the user through the application to ensure that the vehicle 110 is stationary.

In embodiments, the system 100 may ask the user to explain defects related to the vehicle noise if the user recognizes defects. For example, referring to FIGS. 2A and 2B, the application may provide the instructions, such as “Please explain the problem related to vehicle noises in your own words.” The user may explain the issues or problems related to the vehicle noises, for example “Brakes are making noises!” The system 100 may receive information related to the vehicle noise from the user.

Referring to FIGS. 2A and 2B, the system 100 may collect the vehicle noise through the device 120. In embodiments, the vehicle noise comprises a noise from brakes, sway bar links, Constant-Velocity (CV) axles, wheel bearings, valves, rods, water pumps, belts, power steering pumps, exhaust shields, exhaust leaks, or combinations thereof.

The system 100 may collect the vehicle noise through the application on the device 120. For example, referring to FIG. 2B, the application may provide the instructions, such as “Make sure you are seated in your vehicle and vehicle is parked. Place phone in a secure place in your vehicle. Click Record to start explaining problem in your own words and start driving the vehicle as we pick audio from the vehicle. For your safety the recording will stop automatically after 5 minutes.” The user may push the record button to start collecting the vehicle noise, such as “RECORD.”

In embodiments, the system 100 may collect the vehicle noise during a predetermined time. For example, the system 100 may collect the vehicle noises in about 10 minutes, 5 minutes, 3 minutes, 1 minute, or 30 seconds.

Referring to FIGS. 2A and 2C, in response to pushing the record button in FIG. 2B, the system 100 may start collecting the vehicle noise. The system 100 may collect the vehicle noise by a sensor of the device 120, a sensor of the vehicle 110, or both. When the system 100 collects the vehicle noise, the system 100 may provide the following instruction on the application, “Listening,” and present features of the vehicle noise, such as the spectrograms, peak frequencies, wavelengths, or combinations thereof, through the application.

The system 100, for example, the server 240, the vehicle 110, the device 120, or combinations thereof, may convert the vehicle noise to a spectrogram. The spectrogram may refer to a visual representation of a spectrum of frequencies of a signal. The system 100 may convert the vehicle noise to a spectrogram. The system 100 may input the vehicle noises to a machine learning model to obtain a spectrogram. The system 100 may convert the vehicle noise to a Mel spectrogram.

Referring to FIGS. 2A and 2D, the system 100, for example, the server 240, the vehicle 110, the device 120, or combinations thereof, may obtain a fingerprint of the vehicle noise including one or more features of the spectrogram. The system 100, for example, the server 240, the vehicle 110, the device 120, or combinations thereof, may process the vehicle noise to obtain a spectrogram. Then, the system 100 extracts peak frequencies from the spectrogram and calculate time difference between peak frequencies. Based on the combination of the peak frequencies and the time difference, a hash is created. The hash may be a unique fingerprint for the vehicle noise. A fingerprint of the vehicle noise, such as a noise from brakes, sway bar links, Constant-Velocity (CV) axles, wheel bearings, valves, rods, water pumps, belts, power steering pumps, exhaust shields, exhaust leaks, or combinations thereof, may be different from a fingerprint of a noise from the vehicles having no defects. For example, referring to FIG. 2D, each fingerprint of the brake squeal, piston rod knock, and engine knock are different from a normal vehicle, which has no defects.

In embodiments, the system 100, for example, the server 240, the vehicle 110, the device 120, or combinations thereof, may obtain features of the vehicle noise. In embodiments, the system 100 may input the features to a machine learning model to obtain a predicted classification of the vehicle noise. In embodiments, the machine learning model may use a domain-specific audio transformation, a classification algorithm, or both.

In embodiments, the system 100, for example, the server 240, the vehicle 110, the device 120, or combinations thereof, may obtain peak frequencies, wavelengths, or both of the vehicle noise. The system 100 may obtain peak frequencies, wavelengths, or both of the vehicle noise including one or more features of the spectrogram.

The system 100, for example, the server 240, the vehicle 110, the device 120, or combinations thereof, may compare the fingerprint of the vehicle noise and predetermined fingerprints associated with different classifications. The predetermined fingerprint may include a fingerprint of noise from each of brakes, sway bar links, CV axles, wheel bearings, valves, rods, water pumps, belts, power steering pumps, exhaust shields, exhaust leaks, or combinations thereof. For example, referring to FIG. 2D, the predetermined fingerprint may include fingerprints of the brake squeal, piston rod knock, and engine knock. The predetermined fingerprint may further include a fingerprint of a normal vehicle having no defects. For example, referring to FIG. 2D, the predetermined fingerprint may further include a fingerprint of normal driving, which means that sounds from driving of normal vehicles having no defects. In embodiments, the predetermined fingerprints may be audio fingerprints stored in a database of the server 240, the device 120, or the vehicle 110.

In embodiments, the system 100, for example, the server 240, the vehicle 110, the device 120, or combinations thereof, may compare the peak frequencies, the wavelengths, or both, of the vehicle noise and predetermined peak frequencies, predetermined wavelengths, or both, associated with different classifications. The peak frequencies, the wavelengths, or both, of the vehicle noise, such as a noise from brakes, sway bar links, CV axles, wheel bearings, valves, rods, water pumps, belts, power steering pumps, exhaust shields, exhaust leaks, or combinations thereof, may be different from the peak frequencies, the wavelengths, or both, of a noise from the vehicles having no defects.

The system 100, for example, the server 240, the vehicle 110, the device 120, or combinations thereof, may identify a classification of the vehicle noise based on the comparison of the fingerprint of the vehicle noise and the predetermined fingerprints. For example, referring to FIGS. 2A and 2D, when the fingerprint of the vehicle noise is the same as or similar to the fingerprint indicated as “Brake Squeal,” the system 100 may identify a classification of the vehicle noise as noise from defective brakes. For example, referring to FIGS. 2A and 2D, when the fingerprint of the vehicle noise is the same as or similar to the fingerprint indicated as “Piston Rod Knock,” the system 100 may identify a classification of the vehicle noise as noise from defective rods. For example, referring to FIGS. 2A and 2D, when the fingerprint of the vehicle noise is the same as or similar to the fingerprint indicated as “Engine Knock,” the system 100 may identify a classification of the vehicle noise as noise from defective engines. For example, referring to FIGS. 2A and 2D, when the fingerprint of the vehicle noise is the same as or similar to the fingerprint indicated as “Normal Driving,” the system 100 may identify a classification of the vehicle noise as noise from a normal vehicle having no defects.

In embodiments, the system 100, for example, the server 240, the vehicle 110, the device 120, or combinations thereof, may identify a classification of the vehicle noise based on the comparison of the peak frequencies, the wavelengths, or both, of the vehicle noise and the predetermined peak frequencies, the predetermined wavelengths, or both.

In embodiments, the system 100 may display a result of the classification of the vehicle noise on the device 120. The system 100 may display that the vehicle noise is from brakes, sway bar links, CV axles, wheel bearings, valves, rods, water pumps, belts, power steering pumps, exhaust shields, exhaust leaks, or combinations thereof. The system 100 may display that the vehicle noise is from normal driving of the vehicle 110 having no defects.

Referring to FIGS. 2A and 2E, the system 100 may display a result of the classification of the vehicle noise on the device 120, such as “Worn out Brakes.” The system 100 may further display the explanations about the identified vehicle noise, such as “Worn out Brake pads have been detected.” The system 100 may further display the explanations related to general information of the identified vehicle noise, such as “Brake pads typically wear out every 12,000 miles.”

In embodiments, the classification of the vehicle noise may comprise probabilities for different types of vehicle noises. For example, when the fingerprint of the vehicle noise is not same as or similar to the predetermined fingerprints, the system 100, for example, the server 240, the vehicle 110, the device 120, or combinations thereof, may provide probabilities for different types of vehicle noises. For example, the system 100 may provide probabilities for different types of vehicle noises by comparing the fingerprint of the vehicle noise and a plurality of predetermined fingerprints stored in a database in the server 240, the vehicle 110, the device 120, or combination thereof. Specifically, the system 100 may determine that the vehicle noise is related to a brake squeal noise with a 67% of probability and a rod knock with a 33% of probability. As another example, the system 100 may provide probabilities for different types of vehicle noises using a machine learning algorithm such as a random forest classifier. The machine learning algorithm may be trained using a training set including a plurality of spectrograms as input and ground truths such as normal driving sound, brake squeal noise, red knock noise as output. In embodiments, the system 100 may determine that the vehicle noise is related to a brake squeal noise with a 67% of probability and a rod knock with a 33% of probability using a random forest classifier. In embodiments, with a random forest classifier, the system 100 may identify a classification of the vehicle noise with greater than or equal to 75%, 80%, 85%, 90%, 92%, 95%, or 96% accuracy.

In some embodiments, the system 100, for example, the server 240, the vehicle 110, the device 120, or combinations thereof, may collect a vehicle noise and input the vehicle noise to a machine learning model such as a random forest classifier to obtain a predicted classification of the vehicle noise or probability of different types of vehicle noises. For example, a model of random forest classifier may be trained on samples of engine sounds of normal vehicles, which have no defects, and vehicle noises, such as brake squeal noises, rod knock sounds. As described in Table 1, the system 100 may obtain probabilities of different types of vehicle noises as to a plurality of vehicle noises. The Ground Truth in Table 1 means the actual type of noise provided to the random forest classifier. The first sample in Table 1 is a Brake Squeal noise and the random forest classifier predicts that the provided vehicle noise is a brake squeal noise with 63% confidence. The random forest classifier also predicts that the provided vehicle noise is a rod knock with 37% confidence. The second sample in Table 1 is a normal engine sound of a normal vehicle and the random forest classifier predicts that the provided vehicle noise is a normal engine sound of a vehicle with 100% confidence.

TABLE 1

| Normal | Brake | Rod | |
|---|---|---|---|
| Driving | Squeal | Knock | Ground Truth |
| 0.00 | 0.63 | 0.37 | Brake Squeal |
| 1.00 | 0.00 | 0.00 | Normal |
| 1.00 | 0.00 | 0.00 | Normal |
| 0.67 | 0.33 | 0.00 | Normal |
| 0.87 | 0.07 | 0.06 | Normal |
| 1.00 | 0.00 | 0.00 | Normal |
| 1.00 | 0.00 | 0.00 | Normal |
| 0.00 | 0.20 | 0.80 | Rod Knock |
| 0.00 | 0.07 | 0.93 | Rod Knock |

Table 2 depicts prediction results of the random forest classifier. Total 50 samples were provided to the random forest classifier and the random forest classifier provides a predicted classification of the vehicle noise or probability of different types of vehicle noises with 96% accuracy.

TABLE 2

| | | | | F | Overall |
|---|---|---|---|---|---|
| Audio Features | Samples | Precision | Recall | score | Accuracy |
| Normal Driving | 22 | 1 | 1 | 1 | 96% |
| Brake Squeal | 13 | 0.87 | 1 | 0.93 | 96% |
| Rod Knock | 15 | 1 | 0.87 | 0.93 | 96% |

The system 100 may display a result of the classification of the vehicle noise, such as probabilities for different types of vehicle noises, on the device 120. For example, referring to FIGS. 2A and 2F, the system 100 may display a result of the classification of the vehicle noise on the device 120, such as “Worn out Belts,” “Low Power Steering Fluid,” “Bad Wheel Bearing/Tires,” and “Bad CV Axle.” The system 100 may display a result of the classification of the vehicle noise on the device 120 from high probability to low probability. For example, in FIG. 2F, the system 100 may determine that the probability of the vehicle noises from the belts is higher than the probability of the vehicle noises from the steering, wheel bearing/tires, and CV axle. In FIG. 2F, the system 100 may determine that the probability of the vehicle noises from the steering is higher than the probability of the vehicle noises from wheel bearing/tires, and CV axle but lower than the probability of the vehicle noises from the belts. In FIG. 2F, the system 100 may determine that the probability of the vehicle noises from the wheel bearing/tires is higher than the probability of the vehicle noises from CV axle but lower than the probability of the vehicle noises from belts and steering. In FIG. 2F, the system 100 may determine that the probability of the vehicle noises from the CV axle is lower than the probability of the vehicle noises from belts, steering, and wheel bearing/tires. For example, the system 100 may determine that the probability of belts is 40%, the probability of steering is 30%, the probability of wheel bearing/tires is 20%, and the probability of CV axle is 10%.

Referring to FIGS. 2A, 2E, and 2F, in response to identifying the vehicle noises, the system 100 may display a service history of the vehicle 110 on the device 120. The system 100 may display the service history of the vehicle, such as changing tires, changing belts, changing oils, on the device 120.

Still referring to FIGS. 2A, 2E, and 2F, in response to identifying the vehicle noises, the system 100 may display a proposal of visiting a customer service representative to the user. The system 100 may display a proposal of visiting a customer service representative on the device 120. Referring to FIGS. 2A and 2G, in response to receiving an input from the user for the appointment with the customer service representative, the system 100 may schedule an appointment with the customer service representative.

In embodiments, in response to identifying the vehicle noises, the system 100 may send a result of the classification of the vehicle noise to a customer service representative, a user of the vehicle 110, or both. Referring to FIGS. 2A and 2G, the system 100 may schedule an appointment with the customer service representative without an input from the user for the appointment with the customer service representative.

Referring to FIGS. 2A and 2G, the system 100 may display the date, time, service advisor of the appointment with the customer service representative, and transportation to the customer service representative on the device 120. The system 100 may provide options for cancelling, editing, or both of the appointment with the customer service representative.

In embodiments, the system 100 may receive a feedback from the customer service representative, the user of the vehicle, or both. The system 100 may receive a feedback whether the identified vehicle noises are correct or not. The system 100 may receive a feedback regarding unidentified sounds, unidentified noises, or both. An accuracy of the system 100 for analyzing a vehicle noise may be improved based on a feedback. Specifically, the parameters of the machine learning model or the random forest classifier may be adjusted based on the feedback regarding unidentified sounds, unidentified noises, etc.

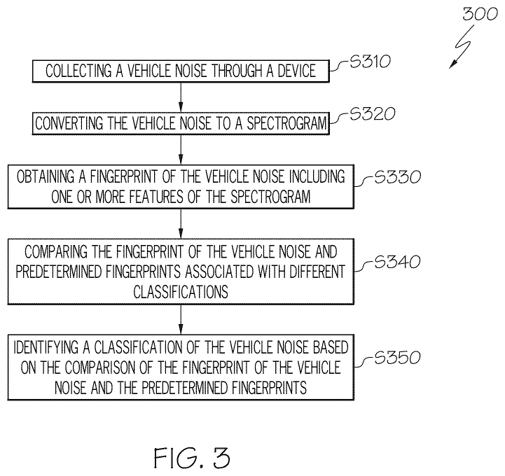

FIG. 3 depicts a flowchart for methods of analyzing a vehicle noise that may be performed by the systems of FIGS. 2A-2G, according to one or more embodiments shown and described herein.

Referring to FIGS. 2A and 3, in step S310, a controller, e.g., the controller of a server 240, may collect a vehicle noise through the device 120. In embodiments, the vehicle noise comprise a noise from brakes, sway bar links, CV axles, wheel bearings, valves, rods, water pumps, belts, power steering pumps, exhaust shields, exhaust leaks, or combinations thereof. The controller may collect the vehicle noise through the application on the device 120. For example, referring to FIG. 2B, the application may provide the instructions, such as “Make sure you are seated in your vehicle and vehicle is parked. Place phone in a secure place in your vehicle. Click Record to start explaining problem in your own words and start driving the vehicle as we pick audio from the vehicle. For your safety the recording will stop automatically after 5 minutes.” The user may push the record button to start collecting the vehicle noise, such as “RECORD.” Referring to FIGS. 2A and 2C, in response to pushing the record button in FIG. 2B, the controller may start collecting the vehicle noise. The controller may collect the vehicle noise by a sensor of the device 120, a sensor of the vehicle 110, or both. When the controller collects the vehicle noise, the controller may provide the following instruction on the application, “Listening.” and present features of the vehicle noise, such as the spectrograms, peak frequencies, wavelengths, or combinations thereof, through the application.

Referring to FIGS. 2A and 3, in step S320, the controller may convert the vehicle noise to a spectrogram. For example, the controller may convert the vehicle noise to a Mel spectrogram.

Referring to FIGS. 2A and 3, in step S330, the controller may obtain a fingerprint of the vehicle noise including one or more features of the spectrogram. A fingerprint of the vehicle noise, such as a noise from brakes, sway bar links, CV axles, wheel bearings, valves, rods, water pumps, belts, power steering pumps, exhaust shields, exhaust leaks, or combinations thereof, may be different from a fingerprint of a noise from the vehicles having no defects. For example, referring to FIG. 2D, each fingerprint of the brake squeal, piston rod knock, and engine knock are different from a normal vehicle, which has no defects.

In embodiments, the controller may obtain features of the vehicle noise. In embodiments, the controller may input the features to a machine learning model to obtain a predicted classification of the vehicle noise. In embodiments, the machine learning model may use a domain-specific audio transformation, a classification algorithm, or both.

In embodiments, the controller may obtain peak frequencies, wavelengths, or both of the vehicle noise. The controller may obtain peak frequencies, wavelengths, or both of the vehicle noise including one or more features of the spectrogram.

Referring to FIGS. 2A and 3, in step S340, the controller may compare the fingerprint of the vehicle noise and predetermined fingerprints associated with different classifications. The predetermined fingerprint may include a fingerprint of noise from each of brakes, sway bar links, CV axles, wheel bearings, valves, rods, water pumps, belts, power steering pumps, exhaust shields, exhaust leaks, or combinations thereof. For example, referring to FIG. 2D, the predetermined fingerprint may include fingerprints of the brake squeal, piston rod knock, and engine knock. The predetermined fingerprint may further include a fingerprint of a normal vehicle having no defects. For example, referring to FIG. 2D, the predetermined fingerprint may further include a fingerprint of normal driving, which means that sounds from a driving of normal vehicles having no defects. In embodiments, the predetermined fingerprints may be audio fingerprints stored in a database.

In embodiments, the controller may compare the peak frequencies, the wavelengths, or both, of the vehicle noise and predetermined peak frequencies, predetermined wavelengths, or both, associated with different classifications.

Referring to FIGS. 2A and 3, in step S350, the controller may identify a classification of the vehicle noise based on the comparison of the fingerprint of the vehicle noise and the predetermined fingerprints. For example, referring to FIG. 2D, when the fingerprint of the vehicle noise is the same as or similar to the fingerprint indicated as “Brake Squeal,” the controller may identify a classification of the vehicle noise as noise from defective brakes. For example, referring to FIG. 2D, when the fingerprint of the vehicle noise is the same as or similar to the fingerprint indicated as “Piston Rod Knock,” the controller may identify a classification of the vehicle noise as noise from defective rods. For example, referring to FIG. 2D, when the fingerprint of the vehicle noise is the same as or similar to the fingerprint indicated as “Engine Knock,” the controller may identify a classification of the vehicle noise as noise from defective engines. For example, referring to FIG. 2D, when the fingerprint of the vehicle noise is the same as or similar to the fingerprint indicated as “Normal Driving,” the controller may identify a classification of the vehicle noise as noise from a normal vehicle having no defects.

In embodiments, the controller may identify a classification of the vehicle noise based on the comparison of the peak frequencies, the wavelengths, or both, of the vehicle noise and the predetermined peak frequencies, the predetermined wavelengths, or both.

In embodiments, the controller may display a result of the classification of the vehicle noise on the device 120. The controller may display that the vehicle noise is from brakes, sway bar links, CV axles, wheel bearings, valves, rods, water pumps, belts, power steering pumps, exhaust shields, exhaust leaks, or combinations thereof. The controller may display that the vehicle noise is from normal driving of the vehicle 110 having no defects. For example, referring to FIGS. 2A and 2E, the controller may display a result of the classification of the vehicle noise on the device 120, such as “Worn out Brakes.” The controller may further display the explanations about the identified vehicle noise, such as “Worn out Brake pads have been detected.” The controller may further display the explanations related to general information of the identified vehicle noise, such as “Brake pads typically wear out every 12,000 miles.”

In embodiments, the classification of the vehicle noise may comprise probabilities for different types of vehicle noises. For example, when the fingerprint of the vehicle noise is not same as or similar to the predetermined fingerprints, the controller may provide probabilities for different types of vehicle noises. For example, the controller may provide probabilities for different types of vehicle noises using a random forest classifier. The random forest classifier may receive plurality of samples of vehicle noises and normal driving, which means that sounds from a driving of normal vehicles having no defects and then trained. In embodiments, the controller may determine that the vehicle noise is related to a brake squeal noise with a 67% of probability and a rod knock with a 33% of probability using a random forest classifier. In embodiments, with a random forest classifier, the controller may identify a classification of the vehicle noise with greater than or equal to 90%, 92%, 95%, or 96% accuracy.

The controller may display a result of the classification of the vehicle noise, such as probabilities for different types of vehicle noises, on the device 120. For example, referring to FIGS. 2A and 2F, the controller may display a result of the classification of the vehicle noise on the device 120, such as “Worn out Belts,” “Low Power Steering Fluid,” “Bad Wheel Bearing/Tires,” and “Bad CV Axle.” The controller may display a result of the classification of the vehicle noise on the device 120 from high probability to low probability.

Referring to FIGS. 2A, 2E, and 2F, in response to identifying the vehicle noises, the controller may display a service history of the vehicle 110 on the device 120. The controller may display the service history of the vehicle, such as changing tires, changing belts, changing oils, on the device 120.

Still referring to FIGS. 2A, 2E, and 2F, in response to identifying the vehicle noises, the controller may display a proposal of visiting a customer service representative to the user. The controller may display a proposal of visiting a customer service representative on the device 120. Referring to FIGS. 2A and 2G, in response to receiving an input from the user for the appointment with the customer service representative, the controller may schedule an appointment with the customer service representative.

In embodiments, in response to identifying the vehicle noises, the controller may send a result of the classification of the vehicle noise to a customer service representative, a user of the vehicle 110, or both. Referring to FIGS. 2A and 2G, the controller may schedule an appointment with the customer service representative without an input from the user for the appointment with the customer service representative.

Referring to FIGS. 2A and 2G, the controller may display the date, time, service advisor of the appointment with the customer service representative, and transportation to the customer service representative on the device 120. The controller may provide options for cancelling, editing, or both of the appointment with the customer service representative.

In embodiments, the controller may receive a feedback from the customer service representative, the user of the vehicle, or both. The controller may receive a feedback whether the identified vehicle noises are correct or not.

For the purposes of describing and defining the present disclosure, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention Rather, these terms are merely intended to identify particular aspects of an embodiment of the present disclosure or to emphasize alternative or additional features that may or may not be utilized in a particular embodiment of the present disclosure.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What is claimed is:

1. A system comprising:
a controller programmed to:
collect a vehicle noise through a device;
convert the vehicle noise to a spectrogram;
obtain a fingerprint of the vehicle noise including one or more features of the spectrogram;
compare the fingerprint of the vehicle noise and predetermined fingerprints associated with different classifications; and
identify a classification of the vehicle noise based on the comparison of the fingerprint of the vehicle noise and the predetermined fingerprints.

2. The system according to claim 1, wherein the controller is further configured to:
obtain features of the vehicle noise; and
input the features to a machine learning model to obtain a predicted classification of the vehicle noise.

3. The system according to claim 2, wherein the machine learning model uses a domain-specific audio transformation, a classification algorithm, or both.

4. The system according to claim 1, wherein the predetermined fingerprints are audio fingerprints stored in a database.

5. The system according to claim 1, wherein the vehicle noise comprise a noise from brakes, sway bar links, Constant-Velocity (CV) axles, wheel bearings, valves, rods, water pumps, belts, power steering pumps, exhaust shields, exhaust leaks, or combinations thereof.

6. The system according to claim 1, wherein the controller is further configured to:
display a result of the classification of the vehicle noise on the device.

7. The system according to claim 1, wherein the controller is further configured to:
send a result of the classification of the vehicle noise to a customer service representative, a user of the vehicle, or both.

8. The system according to claim 7, wherein the controller is further configured to:
schedule an appointment with the customer service representative.

9. The system according to claim 7, wherein the controller is further configured to:
receive a feedback from the customer service representative, the user of the vehicle, or both.

10. The system according to claim 1, wherein the controller is further configured to:
obtain peak frequencies of the vehicle noise;
compare the peak frequencies of the vehicle noise and predetermined peak frequencies associated with different classifications; and
identify a classification of the vehicle noise based on the comparison of the peak frequencies of the vehicle noise and the predetermined peak frequencies.

11. The system according to claim 1, wherein the classification of the vehicle noise comprises probabilities for different types of vehicle noises.

12. A method comprising:
collecting a vehicle noise through a device;
converting the vehicle noise to a spectrogram;
obtaining a fingerprint of the vehicle noise including one or more features of the spectrogram;
comparing the fingerprint of the vehicle noise and predetermined fingerprints associated with different classifications; and
identifying a classification of the vehicle noise based on the comparison of the fingerprint of the vehicle noise and the predetermined fingerprints.

13. The method according to claim 12, further comprising:
obtaining features of the vehicle noise; and
inputting the features to a machine learning model to obtain a predicted classification of the vehicle noise.

14. The method according to claim 13, wherein the machine learning model uses a domain-specific audio transformation, a classification algorithm, or both.

15. The method according to claim 12, wherein the predetermined fingerprints are audio fingerprints stored in a database.

16. The method according to claim 12, wherein the vehicle noise comprise a noise from brakes, sway bar links, Constant-Velocity (CV) axles, wheel bearings, valves, rods, water pumps, belts, power steering pumps, exhaust shields, exhaust leaks, or combinations thereof.

17. The method according to claim 12, further comprising:
displaying a result of the classification of the vehicle noise on the device.

18. The method according to claim 12, further comprising:
sending a result of the classification of the vehicle noise to a customer service representative, a user of the vehicle, or both.

19. The method according to claim 18, further comprising:
scheduling an appointment with the customer service representative.

20. The method according to claim 18, further comprising:
receiving a feedback from the customer service representative, the user of the vehicle, or both.
